(19) United States
(12) Patent Application Publication
(10) Pub. No.: US 2025/0315474 A1
(43) Pub. Date: Oct. 9, 2025

(54) ENCODING SUMMARIZATION FOR IMAGE RETRIEVAL

(71) Applicant: GM Global Technology Operations LLC, Detroit, MI (US)

(72) Inventors: Hila Levi, Rechovot (IL); Guy Heller, Tel Aviv (IL); Dan Levi, Ganei Tikvah (IL)

(21) Appl. No.: 18/630,583

(22) Filed: Apr. 9, 2024

(51) Int. Cl. G06F 16/583; G06F 16/34

(52) U.S. Cl. CPC G06F 16/5846; G06F 16/345

(57) ABSTRACT

A system for image retrieval includes a processing device connected to a database configured to store a set of images. The processing device includes a computer vision model including a text encoder configured to extract textual features and a vision encoder configured to extract image features, and generate embeddings used for image retrieval tasks, and a summarization module configured to be trained using a targeted dataset, the summarization module configured to restrict a number of queries per image that are learnable by the computer vision model to a selected number.

### INTRODUCTION

The subject disclosure relates to computer vision, and more particularly to facilitating image retrieval using textual queries.

Machine learning and computer vision models are increasingly used in various industries, for purposes such as object recognition, image generation, monitoring in automotive applications and others. Classifying images and retrieval of images according to open-set text queries is an important task in computer vision. Open vocabulary models are often used for such purposes. Scalability and efficiency are important factors in development of such models and associated technologies.

### SUMMARY

In one exemplary embodiment, a system for image retrieval includes a processing device connected to a database configured to store a set of images. The processing device includes a computer vision model including a text encoder configured to extract textual features and a vision encoder configured to extract image features, and generate embeddings used for image retrieval tasks, and a summarization module configured to be trained using a targeted dataset, the summarization module configured to restrict a number of queries per image that are learnable by the computer vision model to a selected number.

In addition to one or more of the features described herein, the restricted number of queries results in a restricted number of embeddings that can be used for image retrieval.

In addition to one or more of the features described herein, the processing device is included in a vehicle system.

In addition to one or more of the features described herein, the summarization module is a summarization head attached to a backbone of the computer vision model.

In addition to one or more of the features described herein, the summarization head includes a cross-attention mechanism having a plurality of head layers, a subset of the plurality of head layers being frozen.

In addition to one or more of the features described herein, each head layer receives an image feature and generates embeddings from the image feature based on learning weights, the learning weights only applied to head layers that are not frozen.

In addition to one or more of the features described herein, the computer vision model is a dense open vocabulary model.

In addition to one or more of the features described herein, the computer vision model is a Contrastive Language Image Pre-training (CLIP) model.

In another exemplary embodiment, a method of training a computer vision model includes receiving a targeted dataset, the targeted dataset including a set of images and associated textual information, and inputting the targeted dataset to a computer vision model. The method also includes extracting textual features by a text encoder and extracting image features by an image encoder, and generating embeddings used for image retrieval tasks, wherein a number of embeddings generated by the computer vision model is restricted by a summarization module, the summarization module restricting a number of queries per image learned by the computer vision model to a selected number.

In addition to one or more of the features described herein, the summarization module is a summarization head attached to a backbone of the computer vision model.

In addition to one or more of the features described herein, the summarization head includes a cross-attention mechanism having a plurality of head layers, a subset of the plurality of head layers being frozen.

In addition to one or more of the features described herein, each head layer receives an image feature and generates embeddings therefrom based on learning weights, the learning weights only applied to head layers that are not frozen.

In addition to one or more of the features described herein, the computer vision model is a dense open vocabulary model.

In addition to one or more of the features described herein, the computer vision model is a Contrastive Language Image Pre-training (CLIP) model.

In yet another exemplary embodiment, a computer program product includes a computer-readable memory that has computer-executable instructions stored thereupon, the computer-executable instructions when executed by a processor cause the processor to perform operations. The operations include receiving a targeted dataset, the targeted dataset including a set of images and associated textual information, inputting the dataset to a computer vision model, and training the model based on the targeted dataset, the training including extracting textual features by a text encoder and extracting image features by an image encoder, and generating embeddings used for image retrieval tasks, wherein a number of the embeddings generated by the computer vision model is restricted by a summarization module, the summarization module restricting a number of queries per image learned by the computer vision model to a selected number.

In addition to one or more of the features described herein, the summarization module is a summarization head attached to a backbone of the computer vision model.

In addition to one or more of the features described herein, the summarization head includes a cross-attention mechanism having a plurality of head layers, a subset of the plurality of head layers being frozen.

In addition to one or more of the features described herein, each head layer receives a respective textual feature and an image feature and generates embeddings therefrom based on learning weights, the learning weights only applied to head layers that are not frozen.

In addition to one or more of the features described herein, the computer vision model is a dense open vocabulary model.

In addition to one or more of the features described herein, the computer vision model is a Contrastive Language Image Pre-training (CLIP) model.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts an example of a system for image retrieval, in accordance with an exemplary embodiment;

FIG. 2 depicts a computer vision model including a summarization module, in accordance with an exemplary embodiment;

FIG. 3 depicts a process for training a computer vision model, in accordance with an exemplary embodiment;

FIG. 4 depicts a process for generating embeddings used for image retrieval, in accordance with an exemplary embodiment;

FIG. 5 depicts a first stage of an image retrieval method, in accordance with an exemplary embodiment;

FIG. 6 depicts a second stage of the method of FIG. 5;

FIG. 7 depicts aspects of an image and/or object recognition method; and

FIG. 8 depicts a computer system in accordance with an embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for image retrieval. An embodiment of a system includes a computer vision model including a summarization module (e.g., summarization head attached to the model). The summarization module is tailored to a targeted dataset (e.g., taken from a small target dataset). During training, the summarization module restricts the number of queries that can be learned by the computer vision model for a given dataset (e.g., labeled images). In an embodiment, the summarization module is a summarization head having a number of frozen layers.

Embodiments described herein present numerous advantages and technical effects. The embodiments provide for increased retrieval and classification accuracy and faster inference times as compared to existing approaches. In addition, the embodiments simplify and accelerate the encoding process and can adapt to a target dataset's distribution.

Dense open vocabulary image retrieval (D-OVIR) systems are commonly used with large number of applications, allowing textual querying in a dense manner. Existing D-OVIR frameworks utilize pre-trained open vocabulary models (e.g. dense Contrastive Language Image Pre-training (CLIP) or denseCLIP)), producing large amounts of dense features, sometimes followed by clustering to reduce data and allow large scale retrieval. However, existing approaches present a number of limitations. For example, such approaches show inferior results on target datasets due to domain shifts, and require the storage of large amounts of dense features per image, which prevents scaling. Clustering can be used to address such limitations, but clustering makes image encoding computationally demanding.

Embodiments described herein address such limitations and increase retrieval accuracy on target datasets while restricting the number of image representatives, allowing practical usage without further computations and without the computational cost of existing approaches.

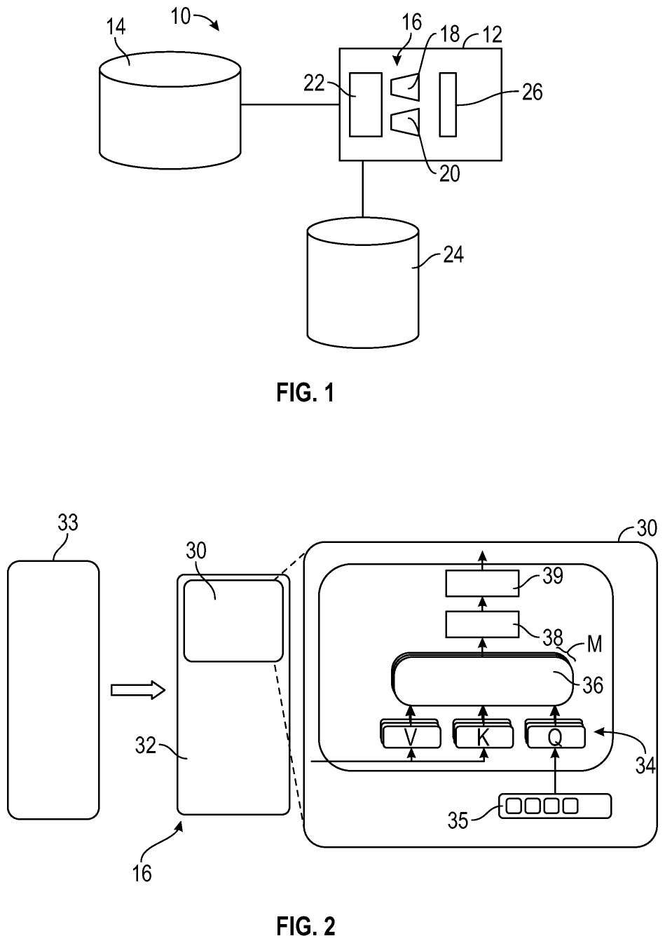

FIG. 1 depicts an example of an image classification and retrieval system 10, which allows for storage of large image datasets, classification of images and retrieval of images using text queries. The system 10 includes a processing device 12 (e.g., a server, workstation, etc.) connected to an indexed image database 14. Images are stored in the database 14 and indexed according to a computer vision or image embedding model 16, such as an open vocabulary model. The open vocabulary model is a learning model including a trained neural network. The model 16 includes an image encoder 18 that represents the network architecture for encoding images, and a text encoder 20 that represents the network architecture for encoding text. The encoders provide a backbone for encoding images and text. A joint embedding space 22 is provided for embedded image and text features (embeddings), which can be stored in an embedding database 24 (or elsewhere, such as the database 14)

The computer vision model 16 is configured to extract image features as embeddings. The embeddings include image embeddings that encode information representing the contents of images, and text embeddings that encode textual information. Embeddings are extracted by the image encoder 18 through sequential processing, and indexed.

Image retrieval (e.g., open vocabulary dense image retrieval) is accomplished by receiving textual information (e.g., a text query) or an image. The text or image is encoded and compared to embeddings in the joint embedding space 22 (e.g., using cosine similarity or other distance metric) to determine similarity between each text embedding and each image embedding. This may be used to, for example, classify and label images, and to retrieve unlabeled images from a database.

In an embodiment, the computer vision model 16 includes a summarization module 26 that is configured to limit the number of learnable queries during training. In other words, the summarization module 26 reduces the number of queries that can be learned and thereby reduces the number of embeddings that are used for image retrieval, which reduces computational requirements while maintaining accuracy and maintaining inherited image-text associations.

The system may be utilized in a variety of applications. For example, the system 10 can be incorporated into image search systems, image generation systems and others. For example, the system 10 can be used to facilitate object recognition and/or classification in vision systems used in automotive applications (e.g., for autonomous and semi-autonomous vehicle control).

Referring to FIG. 2, in an embodiment, the summarization module 26 is a dedicated fine-tuned summarization head 30 that is attached to the backbone of the computer vision model 16 (referred to as a model backbone 32). The summarization head 30, in an embodiment, uses cross-attention between text and image embeddings.

During a retrieval or classification task, the backbone 32 receives textual information, which is fed through the text encoder 20 to produce text embeddings. Similarities between text embeddings and image embeddings are evaluated to determine and retrieve images.

During training, labeled images (e.g., from a target dataset 33) are input to the computer vision model 16 and encoded via the model backbone 32. Learnable queries 35 are acquired and extracted as query vectors Q, and image embeddings are extracted as key vectors K and value vectors V. The vectors K, Q and V are input to the summarization head 30 (layers 34) and then processed using a scaled dot product (SDP) attention process to produce a normalized scaled compatibility matrix and context matrix (layers 36)

In an embodiment, the summarization head 30 uses multi-head attention, in which the vectors are separated into subsets, and each subset is separately processed in a respective head layer to produce separate context matrices. For example, the summarization head 30 includes a number M of layers 34 and layers 36. The context matrices are concatenated (concatenation block 38) to produce a matrix Z. The matrix Z is then multiplied by learnable weights to produce an output embedding with a learned query (block 39).

As shown in FIG. 2, a number of the head layers 34 and 36 (i.e., a subset of the M layers) are frozen, such that weights are not applied to context matrices of the frozen layers. In this way, the number of queries that can be learned per image are restricted to a selected number N. For example, a targeted dataset may have hundreds of learnable queries Q, which can be computationally expensive. The numbers of learnable queries can be reduced (e.g., to 50), to reduce the amount of computational power needed.

For example, the summarization head's layers can be initialized with weights from off-the-shelf open-vocabulary heads (i.e. CLIP). By freezing some of the layers during training, the summarization head 30 has been found to increase retrieval accuracy not only for finetuned categories, but also for zero-shot categories that are unseen through training.

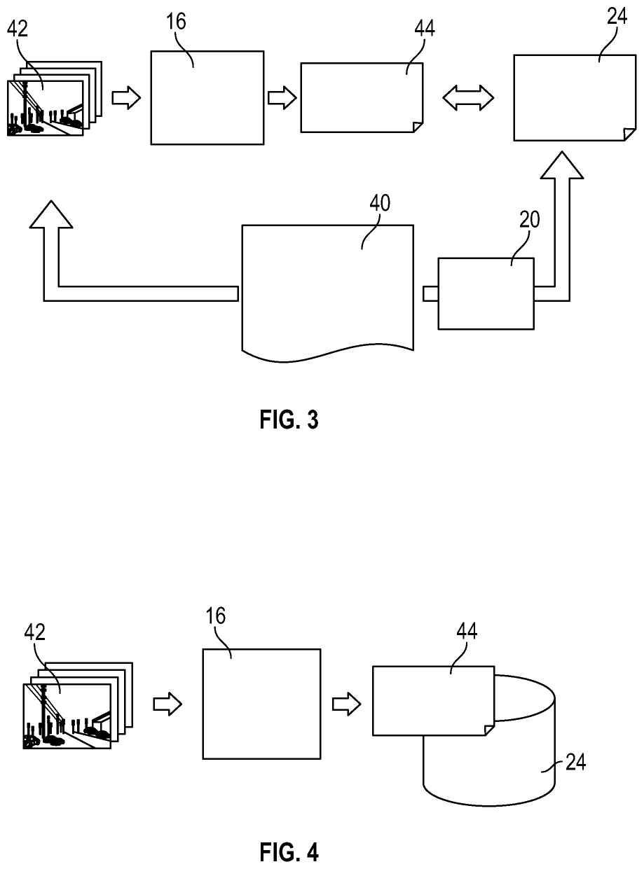

FIG. 3 illustrates aspects of a training phase. For example, the model backbone 32 of FIG. 2 receives a targeted dataset 40 from a remote location or remote model that has been trained on large-scale data. The domain shifts from this transfer are compensated for by the summarization head 30.

The targeted dataset 40 includes images 42 and associated labels. The summarization head 30 is fine tuned by collecting a set of images from the large-scale dataset and associated labels and training the computer vision model 16. As some of the attention layers are frozen, the number of learnable queries is limited to a relatively small number (as compared to the number of queries that would be learned without the summarization head). By restricting the number of learnable queries, the fine tuned head is limited to extract a subset (e.g., only a small number) of representatives per image, which eliminates the need for clustering and improved inference time. This is also beneficial for incorporating the system 10 into a large-scale retrieval network.

For example, as shown, the computer vision model 16 receives a set of learnable queries and outputs a set of embeddings 44 for each image. The number of embeddings (referred to as “summarized embeddings” 44) for a given image is restricted to be equal to a selected number, thereby restricting the number of learnable queries. The summarized embeddings 44 may be stored in the embedding database 24. The number of embeddings in the summarized embeddings 44 is equal to the restricted number of queries that are learned. The summarized embeddings 44 may be matched to existing stored embeddings and labels to further train the model.

Existing dense open-vocabulary fine tuned approaches usually produce hundreds of embeddings per image (and are thus considered ill-suited for retrieval tasks), sometimes with an additional clustering module, which reduces the number of embeddings but makes the image encoding computationally demanding. The fine tuned computer vision model 16 simplifies and accelerates the encoding process by directly extracting a small number of representatives per image, essential for large-scale retrieval systems at the object level.

FIG. 4 depicts aspects of an inference phase. In the inference phase, unlabeled images 42 are processed by the computer vision model 16, producing a set of summarized embeddings 44. The summarized embeddings 44 may be output to the embedding database 24. As shown, the summarized embeddings 44 are directly output from the model 16 (e.g., without any clustering).

As discussed above, the fine tuned computer vision model 16 is highly applicable for retrieval and classification tasks and can be incorporated within such frameworks in offline or online applications.

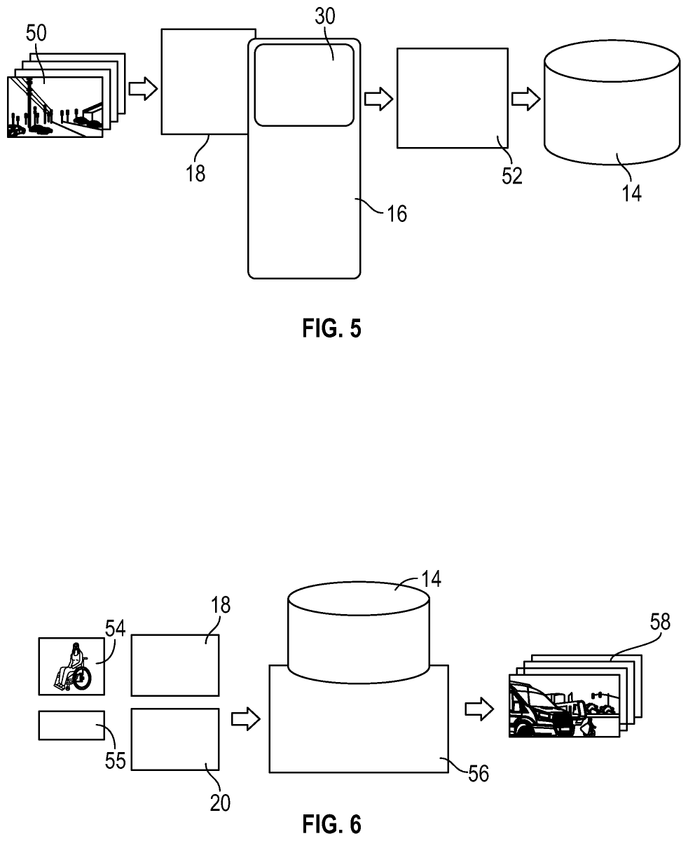

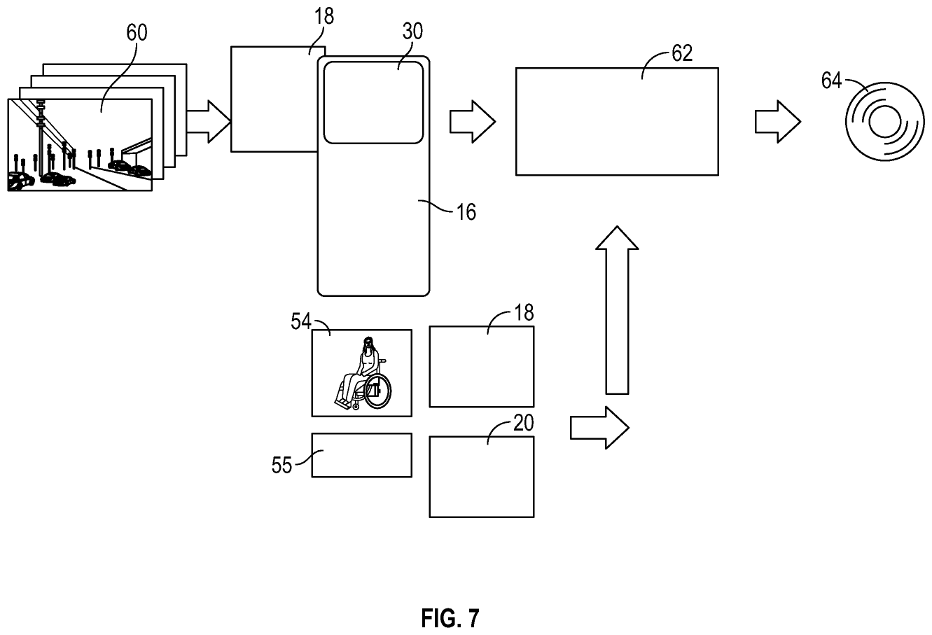

FIGS. 5 and 6 depict an example of an offline method of image retrieval based on an input image or text prompt. FIG. 5 illustrates a first stage of the method, in which dense embeddings are gathered and indexed. A set of images 50 is input to the computer vision model 16, and the image encoder 18 (e.g., patch based image encoder) generates embeddings related to the set of images. The embeddings are used to index the images to allow for quick retrieval (represented by block 52).

Referring to FIG. 6, a visual query such as an image 54 of a wheelchair, or a text prompt 55 (e.g., “wheelchair”) is input to the computer vision model 16. Depending on the type of input, the vision encoder or the text encoder extracts features and searches relevant embeddings in the indexed database (block 56). The embeddings may be selected based on one or more relevant concepts (e.g., “wheelchair”). Images 58 in the database having the greatest similarity can then be output.

FIG. 7 depicts an online method, which may be used by a vehicle system (e.g., for environment monitoring, driver assist, alerts, autonomous control, etc.) or other system that employs image recognition.

In this example, a stream of images 60 (e.g., from a video camera) is received and input to the computer vision model 16. The image encoder 18 extracts image embeddings. An image (e.g., the image 54) or text input (e.g., the text prompt 55) is used to select objects or other features that are desired to be detected. A search is performed for embeddings associated with the desired features or objects (block 62).

If a feature or object is detected, various actions can be performed. For example, the stream of images can be recorded (stored) in a suitable storage location 64. In other examples, if the stream of images 60 is from a vehicle camera, an alert can be generated, the stream of images 60 can be displayed to a driver and/or the vehicle can react autonomously (e.g., perform an evasive maneuver).

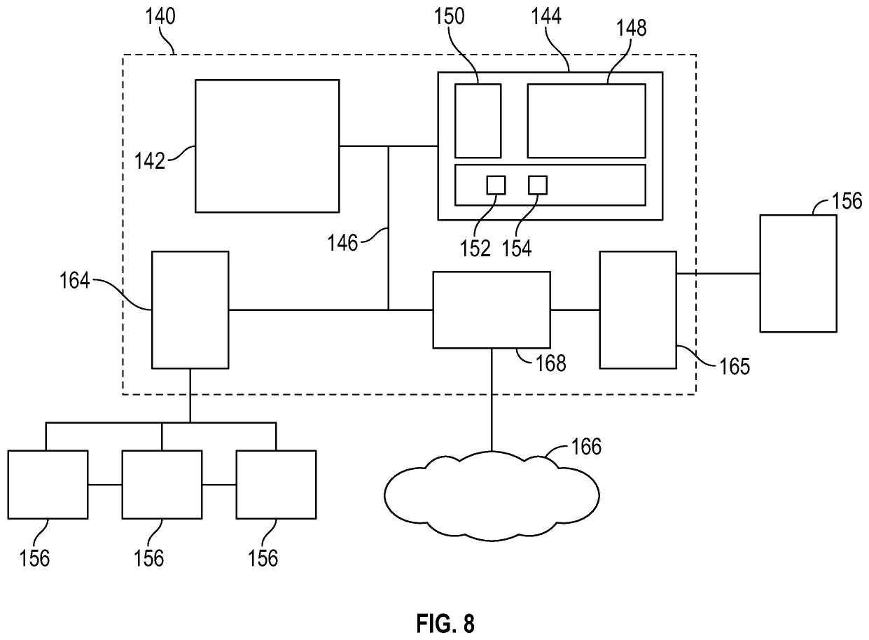

FIG. 8 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included to perform functions related to acquiring images. A module 154 may be included for training and image retrieval as described herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for image retrieval, comprising:
a processing device connected to a database configured to store a set of images, the processing device including:
a computer vision model including a text encoder configured to extract textual features and a vision encoder configured to extract image features, and generate embeddings used for image retrieval tasks; and
a summarization module configured to be trained using a targeted dataset, the summarization module configured to restrict a number of queries per image that are learnable by the computer vision model to a selected number.

2. The system of claim 1, wherein the restricted number of queries results in a restricted number of embeddings that can be used for image retrieval.

3. The system of claim 1, wherein the processing device is included in a vehicle system.

4. The system of claim 1, wherein the summarization module is a summarization head attached to a backbone of the computer vision model.

5. The system of claim 4, wherein the summarization head includes a cross-attention mechanism having a plurality of head layers, a subset of the plurality of head layers being frozen.

6. The system of claim 5, wherein each head layer receives an image feature and generates embeddings from the image feature based on learning weights, the learning weights only applied to head layers that are not frozen.

7. The system of claim 1, wherein the computer vision model is a dense open vocabulary model.

8. The system of claim 7, wherein the computer vision model is a Contrastive Language Image Pre-training (CLIP) model.

9. A method of training a computer vision model, comprising:
receiving a targeted dataset, the targeted dataset including a set of images and associated textual information;
inputting the targeted dataset to a computer vision model;
extracting textual features by a text encoder and extracting image features by an image encoder, and generating embeddings used for image retrieval tasks, wherein a number of embeddings generated by the computer vision model is restricted by a summarization module, the summarization module restricting a number of queries per image learned by the computer vision model to a selected number.

10. The method of claim 9, wherein the summarization module is a summarization head attached to a backbone of the computer vision model.

11. The method of claim 10, wherein the summarization head includes a cross-attention mechanism having a plurality of head layers, a subset of the plurality of head layers being frozen.

12. The method of claim 11, wherein each head layer receives an image feature and generates embeddings therefrom based on learning weights, the learning weights only applied to head layers that are not frozen.

13. The method of claim 9, wherein the computer vision model is a dense open vocabulary model.

14. The method of claim 13, wherein the computer vision model is a Contrastive Language Image Pre-training (CLIP) model.

15. A computer program product comprising a computer-readable memory that has computer-executable instructions stored thereupon, the computer-executable instructions when executed by a processor cause the processor to perform operations comprising:
receiving a targeted dataset, the targeted dataset including a set of images and associated textual information;
inputting the dataset to a computer vision model; and
training the model based on the targeted dataset, the training including extracting textual features by a text encoder and extracting image features by an image encoder, and generating embeddings used for image retrieval tasks, wherein a number of the embeddings generated by the computer vision model is restricted by a summarization module, the summarization module restricting a number of queries per image learned by the computer vision model to a selected number.

16. The computer program product of claim 15, wherein the summarization module is a summarization head attached to a backbone of the computer vision model.

17. The computer program product of claim 16, wherein the summarization head includes a cross-attention mechanism having a plurality of head layers, a subset of the plurality of head layers being frozen.

18. The computer program product of claim 16, wherein each head layer receives a respective textual feature and an image feature and generates embeddings therefrom based on learning weights, the learning weights only applied to head layers that are not frozen.

19. The computer program product of claim 15, wherein the computer vision model is a dense open vocabulary model.

20. The computer program product of claim 19, wherein the computer vision model is a Contrastive Language Image Pre-training (CLIP) model.
